(19) United States
(12) Patent Application Publication
(10) Pub. No.: US 2015/0026818 A1
(43) Pub. Date: Jan. 22, 2015

(54) METHOD AND DEVICE FOR PROVIDING TEMPORARY CONTACT INFORMATION

(71) Applicant: Alcatel Lucent, Boulogne Billancourt (FR)

(72) Inventors: Hyo Seop LEE, Seoul (KR); Kwangwoong KIM, Seoul (KR); Clinton Randy GILES, Murray Hill, NJ (US); Wonsuck LEE, Basking Ridge, NJ (US)

(21) Appl. No.: 14/328,990

(22) Filed: Jul. 11, 2014

(30) Foreign Application Priority Data
Jul. 16, 2013 (KR) 10-2013-83867

(51) Int. Cl. G06F 21/60

(52) U.S. Cl. CPC G06F 21/60
USPC 726/26

(57) ABSTRACT

A device includes a storage unit, a processor and an output unit. The storage unit is configured to store identification information and a plurality of temporary contact data items. The processor is configured to select one of the temporary contact data items based on the identification information and a first time index. The output unit is configured to output the selected temporary contact data item. The selected contact data item may include at least one of, e.g. a temporary telephone number, a temporary email address, a temporary IP address, and a temporary uniform resource identifier (URI).

### CROSS REFERENCE TO RELATED APPLICATION

This application claims priority from Korean patent application No. 10-2013-83867, filed in the Korean Intellectual Property Office on Jul. 16, 2013, the entire disclosure of which is incorporated herein by reference.

### TECHNICAL FIELD

Embodiments of the present disclosure relate generally to information security.

### INTRODUCTION

The recent explosive growth in electronic communication technologies has led to a drastic increase in types and numbers of electronic communication means available for personal communication. Not so long ago, wired telephones used to be virtually the sole electrical communication means for an individual to contact one another. Nowadays, however, with the world-wide deployment of mobile communication systems and the Internet, in addition to wired telephones, mobile phones, e-mails, social network services, and various other means are used for personal communication. In today's world, it is not uncommon for a person to have multiple personal communication means and contact information assigned thereto (e.g., telephone numbers, email addresses, etc.).

With the proliferation of such various electronic communication means, however, the acts of misappropriating and misusing personal contact information for illegal and improper activities, such as phishing and spamming, have also drastically increased in number over the years. Currently, there are many possible ways for one's contact information to be leaked to questionable people and used for illegal and improper purposes. For example, business cards given out to clients may come under possession of identity thieves or criminals, and the telephone numbers and the email addresses printed on the business cards may be used in phishing or other types of scams. Despite the above risks, however, in this ever-connected world, it is very difficult for a person to lead an ordinary life without disseminating some kind of personal contact information.

### SUMMARY OF THE DISCLOSURE

Embodiments of the disclosed subject matter are directed to addressing one or more of the problems set forth above by providing methods and devices that allow an individual to be contacted by others via electronic communication means without the aforementioned risks associated with exposing personal contact information. The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

Some embodiments provide a device, e.g., for providing temporary contact information. In such embodiments, the device may include a storage unit configured to store identification information of the device and a plurality of temporary contact data items. In such embodiments, the device may further include a processor configured to: select one of the temporary contact data items based on the identification information and a first time index; and an output unit configured to output the selected temporary contact data item as the temporary contact information. According to some embodiments of the device described above, the device further comprises a clock and the first time period number is related to a current time of the clock.

In other embodiments, a device is provided, e.g. for providing actual contact information. In such embodiments, the device may include a storage unit configured to store a plurality of actual contact data items of a plurality of respective communication devices in association with identification information of TCI generating devices. In such embodiments, the device may further include a processor configured to: receive temporary contact information; generate identification information based on the temporary contact information and a first time index for the temporary contact information, the identification information identifying one of the TCI generating devices that generated the temporary contact information; and retrieve one of the actual contact data items associated with the identification information from the storage unit. According to some embodiments of the device described above, the processor comprises a time conversion unit configured to generate the first time index based on a time of receiving the temporary contact information.

In yet other embodiments, a method is provided, e.g. for providing temporary contact information in a device. In such embodiments, the method may include: retrieving identification information of the device from a storage unit, the storage unit storing a plurality of temporary contact data items; selecting one of the temporary contact data items based on the retrieved identification information and a first time index; and outputting the selected temporary contact data item as the temporary contact information.

In yet other embodiments, a method is provided, e.g. for providing actual contact information. In such embodiments, the method may include: receiving temporary contact information; generating identification information based on the temporary contact information and a first time index for the temporary contact information, the identification information identifying a TCI generating device that generated the temporary contact information; and retrieving, from a storage unit storing a plurality of actual contact data items of a plurality of respective communication devices, one of the actual contact data items associated with the identification information.

### BRIEF DESCRIPTION OF DRAWINGS

FIG. 1 is a schematic diagram of a temporary phone number (TPN) communication system 100 according to one embodiment of the present disclosure.

FIG. 2 is a block diagram of an illustrative embodiment of the TPN generator shown in FIG. 1.

FIG. 3A is an illustration of a plurality of TPN items stored in a TPN database indexed with numbers ranging from 1 to the total number of TPN items according to one embodiment of the present disclosure.

FIG. 3B illustrates a non-limiting example in which a TPN database includes five TPN sub-databases

FIG. 4A is an illustration of a TPN generator displaying a TPN in accordance with one embodiment of the present disclosure.

FIG. 4B is an illustration of a TPN generator displaying a TPN in accordance with another embodiment of the present disclosure.

FIG. 5 is a block diagram of an illustrative embodiment of the telephone switch shown in FIG. 1.

FIG. 6 is a block diagram of the actual telephone number (APN) server shown in FIG. 1.

FIG. 7A is an illustration of a plurality of TPN items in a TPN database indexed with numbers ranging from 1 to the total number of TPN items according to one embodiment of the present disclosure.

FIG. 7B illustrates a non-limiting example in which a TPN database includes five TPN sub-databases.

FIG. 8 is an illustration of a plurality of APN items stored in association with a plurality of TPN serial numbers of TPN generators according to one embodiment of the present disclosure.

FIG. 9 is a flowchart of a method, performed by a TPN generator, for generating and displaying a TPN according to one embodiment of the present disclosure.

FIG. 10 is a flowchart of a method, performed by a telephone switch, for forwarding a communication request according to one embodiment of the present disclosure.

FIG. 11 is a flowchart of a method, performed by an APN server, for providing an APN of a destination communication terminal according to one embodiment of the present disclosure.

FIG. 12 is an illustration of a temporary contact information (TCI) generator displaying a temporary email address in accordance with one embodiment of the present disclosure.

FIG. 13 is a schematic diagram of a TCI communication system according to an embodiment of the present disclosure.

FIG. 14 is an illustration of a plurality of TCI items stored in a TCI database in association with a plurality of TCI indices according to one embodiment of the present disclosure.

FIG. 15 is an illustration of a plurality of TCI indices stored in a TCI database in association with a plurality of TCI items according to one embodiment of the present disclosure.

FIG. 16 is an illustration of a plurality of ACI items stored in an ACI database in association with a plurality of TCI serial numbers of TCI generators according to one embodiment of the present disclosure.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

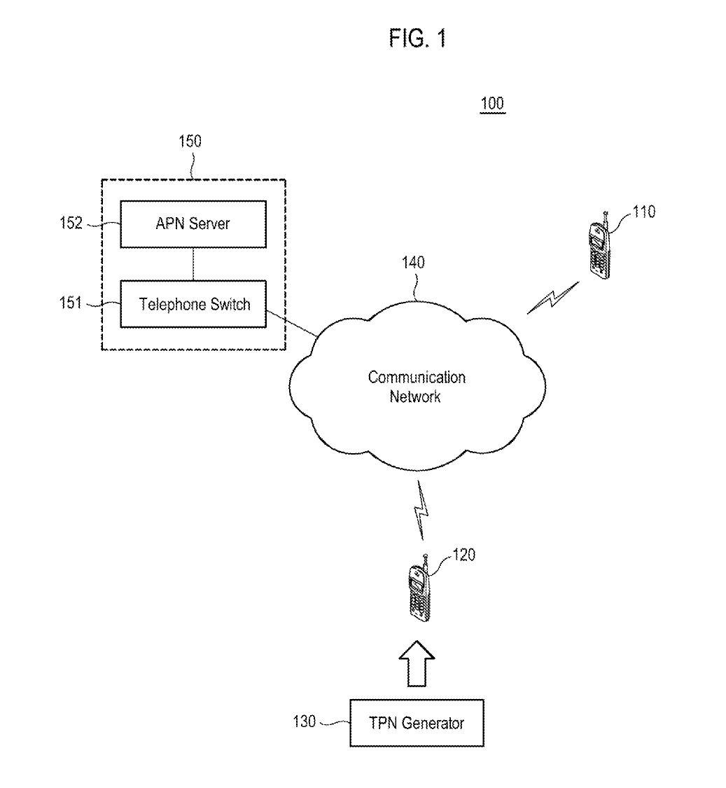

FIG. 1 is a schematic diagram of a temporary phone number (TPN) communication system 100 according to one embodiment of the present disclosure. Referring to FIG. 1, the TPN communication system 100 may include: first and second communication terminals 110 and 120, a TPN generator 130, a communication network 140, and a backend service provider 150.

The first and second communication terminals 110 and 120 may be configured to communicate with each other, the backend service provider 150, and optionally, other entities (not shown) via the communication network 140. While the first and second communication terminals 110 and 120 are illustrated in FIG. 1 as being mobile phones, they may be any type of communication terminals configured to communicate with other entities. Examples of such communication terminals include, but are not limited to, wired telephones, Voice over Internet Protocol (VoIP) terminals, and smart phones.

The TPN generator 130 may be configured to generate and output a TPN for a particular communication terminal (e.g., the second communication terminal 120). The term “TPN,” as used herein, refers to a phone number that may be used for a limited period of time to allow other communication terminals (e.g., the first communication terminal 110) to communicate to a particular communication terminal, for which that phone number was generated and provided (e.g., the second communication terminal 120). In one embodiment, the TPN generator 130 may include a user interface (e.g., a key and a screen) configured to receive a key input, and in response, display a TPN generated by the TPN generator 130, such that the user of the TPN generator 130 may make the TPN available to others to allow them to contact the user at the TPN 120. In another embodiment, the TPN generator 130 may be configured to automatically generate and regularly update TPNs. In yet another embodiment, described further below, the functionality of the TPN generator 130 may be provided by components of the second communication terminal 120, e.g. a processor and memory of the terminal 120.

In one embodiment, the TPN generator 130 may be configured to store identification information of the TPN generator 130 (e.g., a TPN serial number assigned to the TPN generator 130) and a plurality of TPN items, and select one of the TPN items as a TPN based on the stored TPN serial number and the current time provided by a clock (not shown). The clock, for example, may be installed inside the TPN generator 130, and generate a number indicative of the current time, date, and/or year in predetermined time units. By way of a non-limiting example, the number indicative of the current time may be in a Unix time format. As well known in the art, Unix time (or POSIX time) is a system for describing instants in time, defined as the number of seconds that have elapsed since 00:00:00 Coordinated Universal Time (UTC), Jan. 1, 1970. For example, 18:01:00 UTC, Jan. 1, 1970 is 64860 seconds (=18×60×60+1×60) in Unix time (meaning that 64860 seconds has elapsed since 00:00:00 UTC, Jan. 1, 1970).

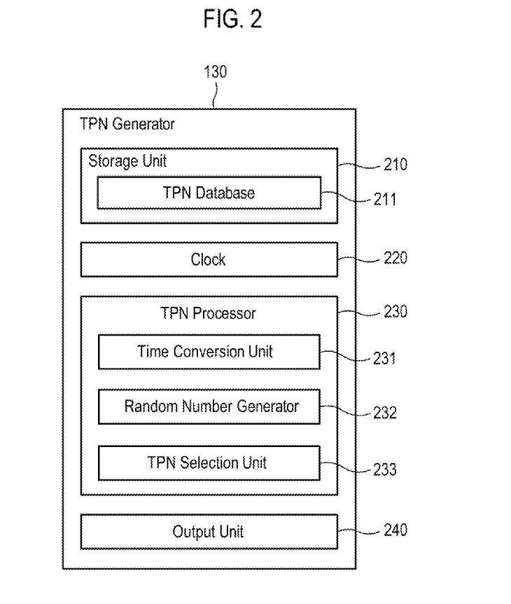

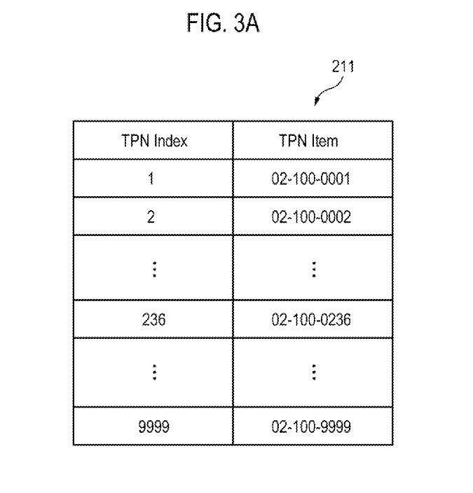

In one embodiment, for generating a TPN, the TPN generator 130 may convert the current Unix time, e.g. a number in the time unit of seconds, to a time index (e.g., a time period number) corresponding to one of a series of successive predetermined time periods (e.g. a series of successive one hour-long time periods starting from 00:00:00 UTC, Jan. 1, 1970). For example, when the time period numbers correspond to successive one hour-long time periods, the TPN generator 130 may convert the Unix time of 64860 seconds to the time period number 18 by first dividing 64860 by 3600 (3600 seconds=1 hour) and then truncating the quotient (i.e., 18.02) to the nearest integer (i.e., 18). In another example, when the time period numbers correspond to successive six hour-long time periods, the TPN generator 130 may convert the Unix time of 64860 seconds to the time period number 3 by first dividing 64860 by 21600 (21600 seconds=6 hours) and then truncating the quotient (i.e., 3.003) to the nearest integer (i.e., 3). The time period number, together with the TPN serial number of the TPN generator 130, may be used to generate the TPN. Further technical details relating to the techniques of generating and outputting a TPN will be explained later in more detail with reference to FIGS. 2, 3A, and 3B.

The communication network 140 may include a plain old telephone network (POTN), a mobile network, a data communication network, etc., through which communication requests may be relayed and/or routed to establish communication between any entities connected thereto (e.g., between the first and second communication terminals 110 and 120). In one embodiment, the communication network 140 may be comprised of one or more public and/or private communication networks. Examples of such communication networks include, but are not limited to, a Public Switched Telephone Network (PSTN), a Public Land Mobile Network (PLMN), and the Internet.

The backend service provider 150 may be communicatively coupled to the communication network 140 and may be configured to assist in establishing communication between communication terminals (e.g., the first and second communication terminals 110 and 120) using a TPN. In one embodiment, the backend service provider 150 may include a telephone switch 151 and an actual phone number (APN) server 152. The telephone switch 151 may be subscribed to and assigned a plurality of phone numbers provided by a communication service provider (e.g., a public telephone company operating the PSTN in the communication network 140), such that call requests directed to the assigned phone numbers can be automatically routed and relayed to the telephone switch 151 through the communication network 140. At least a subset of the phone numbers assigned to the telephone switch 151 may be the plurality of TPN items stored in the TPN generator 130.

In one embodiment, the telephone switch 151 may be configured to, upon receiving a communication request directed to one of its phone numbers assigned (i.e., a TPN), extract the TPN from the communication request, and send the extracted TPN to the APN server 152. Further, the telephone switch 151 may be configured to, upon receiving an APN corresponding to the extracted TPN, forward the received communication request toward a communication terminal having the APN as an actual phone number (e.g., the second communication terminal 120) to establish a call between the calling and called parties established.

The APN server 152 may be configured to, upon receiving a TPN, obtain and send to the telephone switch 151 an APN corresponding to the received TPN. In one embodiment, the APN server 152 may be configured to store a plurality of APNs in association with a plurality of serial numbers (the serial numbers being respectively assigned to the TPN generators subscribed to the backend service provider 150), and upon receiving a TPN, generate a serial number, select one of the stored APNs, which is associated with the same serial number as the generated serial number, as the APN corresponding to the TPN. By way of a non-limiting example, the APN server 152 may be configured to generate such serial number based on the received TPN and the time of arrival of the received TPN (e.g., the time the APN server 152 received the TPN from the telephone switch 151) through a computation inverse to that performed in the TPN generator 130 to generate the same TPN as the received one. The time of arrival may be provided by a clock (not shown), which, for example, may be installed inside the APN server 152. For example, if the TPN is received at 18:51:00 UTC, Jan. 1, 1970, the clock may provide 67860 seconds (=18×60×60+51×60) in Unix time (meaning that 67860 seconds has elapsed since 00:00:00 UTC, Jan. 1, 1970).

In one embodiment, the APN server 152 may be configured to, in generating a serial number from the received TPN, convert the number indicative of the time of arrival to a time index (e.g., a time period number) in a manner similar to that described with respect to the TPN generator 130. For example, when the time period numbers correspond to successive one hour-long time periods, the APN server 152 may convert the Unix time of 67860 seconds to the time period number 18 by first dividing 67860 by 3600 (3600 seconds=1 hour) and then truncating the quotient (i.e., 18.850) to the nearest lower integer (i.e., 18). In another example, if the time period numbers correspond to successive six hour-long time periods, the APN server 152 may convert the Unix time of 67860 seconds to the time period number 3 by first dividing 67860 with 21600 (21600 seconds=6 hour) and then truncating the quotient (i.e., 3.142) to the nearest lower integer (i.e., 3).

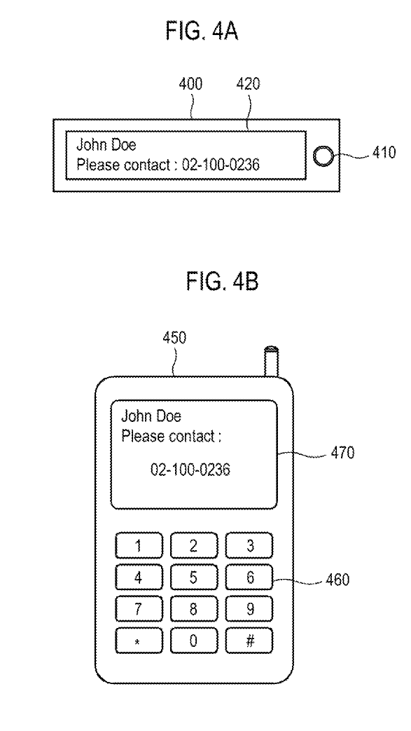

In the above non-limiting example, even though the time at which the TPN generator 130 determined the TPN does not exactly match the time the APN server 152 received the TPN, adjustments to the numbers may be made such that the APN server 152 and the TPN generator 130 can respectively base the generation of the serial number and the determination of the TPN on the same number. In this fashion, the APN server 152 may be allowed to obtain the serial number of the TPN generator 130, which generated the corresponding TPN, through inverse computation. Further technical details relating to the techniques of obtaining an APN corresponding to a TPN will be explained later in more detail with reference to FIGS. 5, 6, 7A, 7B, and 8.

FIG. 2 is a detailed block diagram of an illustrative embodiment of the TPN generator shown in FIG. 1. The TPN generator 130, without limitation, may include: a storage unit 210; a clock 220; a TPN processor 230; and an output unit 240.

The storage unit 210 may be configured to store identifying information (e.g., the serial number, such as ABCD0001) of the TPN generator 130 and a plurality of temporary contact data items (e.g., a plurality of TPN items). In one embodiment, the storage unit 210 may include a TPN database 211 for storing a plurality of TPN items indexed with numbers ranging from 1 to the total number of TPN items. FIG. 3A illustrates a non-limiting example in which the TPN database 211 stores 9999 TPN items ranging from 02-100-0001 to 02-100-9999 respectively indexed with natural numbers from 1 to 9999.

Referring back to FIG. 2, in one embodiment, the clock 220 may be configured to provide the current time. In one embodiment, as was described with respect to FIG. 1, the clock 220 may be configured to generate a number indicative of the current time, date, and/or year in predetermined time units (e.g., 64860 seconds in Unix time, meaning that 64860 seconds has elapsed since 00:00:00 UTC, Jan. 1, 1970). The clock 220 may include, without limitation, any known components and mechanisms (e.g., an oscillator and associated circuitry) that may be used to measure and provide the current time.

The TPN processor 230 may operate to control the overall operations of the TPN generator 130. In one embodiment, the TPN processor 230 may include a time conversion unit 231 configured to convert the number indicative of the current time provided by the clock 220 to a time index (e.g., a time period number) corresponding to one of a series of successive predetermined time periods (e.g. a series of successive one hour-long time periods starting from 00:00:00 UTC, Jan. 1, 1970). For example, if the time period numbers correspond to successive six hour-long time periods, the time conversion unit 231 may convert the Unix time of 64860 seconds to the time period number 3 in a manner similar to that described with respect to FIG. 1,.

In one embodiment, the TPN processor 230 may further include a random number generator 232 configured to generate a random number based on the serial number stored in the storage unit 210 and the time period number provided by the time conversion unit 231. Any random number generating algorithm may be employed to generate a random number from the stored serial number and the time period number provided by the time conversion unit 231.

In one embodiment, the random number may be generated according to the following equation:

R=(S+random(t))mod(TPN_#) (Eq. 1)

where R denotes a random number, S denotes a serial number, random( ) denotes a random number generating function, t denotes a time period number, TPN_# denotes the total number of TPN items in a TPN database of a TPN generator, and S is smaller than TPN_#. Any random number generating function (e.g., the linear congruential generating function) may be employed in generating the random number. In cases where the serial number is comprised of alphanumeric characters, hexatridecimal (base 36) numbers, instead of decimal numbers, may be used in the above equation.

In the above embodiment, when the serial number is a fixed value and the total number of TPN items is 9999, the random number generator 232 may generate a total of 9999 possible natural numbers ranging from 1 to 9999. For instance, if the time conversion unit 231 provides the time period number 3 corresponding to three six-hour periods between 18:00:00 UTC, Jan. 1, 1970 and 23:59:59 UTC, Jan. 1, 1970, the random number generator 232 may generate the random number 236.

In one embodiment, the TPN processor 230 may further include a TPN selection unit 233 that may be configured to select one of the TPN items corresponding to one of the TPN indices in the TPN database 211 that matches the random number generated by the random number generator 232. For instance, if the random number generator 232 generates the random number 236, the TPN selection unit 233 may select the TPN item 02-100-0236, which is associated with the same TPN index 236 in the TPN database 211 (see FIG. 3A).

Further, while the clock 220 and the time conversion unit 231 in the above embodiment has been respectively described as providing a number indicative of the current time and converting the number indicative of the current time to a time period number, it should be appreciated that the clock 220 and the time conversion unit 231 may operate in a different manner to generate the time period number. In one embodiment, the clock 220 may be configured to provide a clock signal of a predetermined period. In this embodiment, the time conversion unit 231 may be configured to receive the clock signal from the clock 220 and generate the time period number based on the received clock signal. By way of a non-limiting example, the time conversion unit 231 unit may generate the time period number, and regularly update the time period number at the passing of a predetermined period of time as determined from the received clock signal. In the above example, the time conversion unit 231 may continuously generate time period numbers indicative of the current time, date, and/or year.

In one embodiment, the TPN generator 130 may further include a data receiving unit (not shown) configured to receive a new serial number and/or a new version of the TPN database 211, for example, from the APN server 152. By way of a non-limiting example, the data receiving unit may comprise one or more key buttons, a universal serial bus (USB) interface, a wireless communication interface, and/or any other means for receiving data from other entity.

In one embodiment, the time conversion unit 231 of the TPN generator 130 may be configured to support a plurality of sets of predetermined time periods by converting the numbers provided by the clock 220 to the numbers corresponding to one of the plurality of sets of predetermined time periods (e.g., a first set of successive one-hour long time periods, a second set of successive six-hour long time periods, etc.).

In the above embodiment, the TPN generator 130 may further include an input unit (not shown) for receiving an input to select one of the multiple different sets of predetermined time periods to be used in the time conversion.

In the above embodiment, the storage unit 210 may store a plurality of TPN databases respectively associated with the plurality of sets of predetermined time periods. FIG. 3B illustrates a non-limiting example in which the TPN database 211 includes five TPN sub-databases (i.e., TPN sub-databases A to E), and each of the TPN sub-databases stores 9999 number of TPN items for the plurality of sets of predetermined time periods of different durations. For example, the TPN sub-database A may provide TPN items for the first set of successive one-hour long time periods, and the TPN sub-database B may provide TPN items for the first set of successive six-hour long time periods. By way of a non-limiting example, each of the plurality of TPN databases may store a range of TPN items that do not overlap with the TPN items stored in other TPN databases. For instance, as shown in FIG. 3B, the TPN sub-database A associated with the first set of successive one-hour long time periods may store TPN items ranging from 02-100-0001 to 02-100-9999, whereas the TPN sub-database B associated with the second set of successive six-hour long time periods may store TPN items ranging from 02-200-0001 to 02-200-9999.

In the above embodiment, the TPN selection unit 233 may be configured to select one of the TPN items as a TPN from the TPN sub-database that is associated with the selected set of predetermined time periods. For instance, if the first set of time periods is selected, the TPN selection unit 233 may select a TPN from the TPN sub-database A, whereas if the second set of time periods is selected, the TPN selection unit 233 may select a TPN from the TPN sub-database B.

The output unit 240 may be configured to output the TPN item selected by the TPN selection unit 233 as a TPN. In one embodiment, the output unit 240 may be configured to output the TPN to at least one of a display device, a speaker, or a tactile device, for example, installed in the TPN generator 130.

The TPN generator described hitherto may be implemented in various ways and under numerous settings to effectively provide a TPN to the user who wishes to allow other persons to contact him with the TPN instead of his actual phone number.

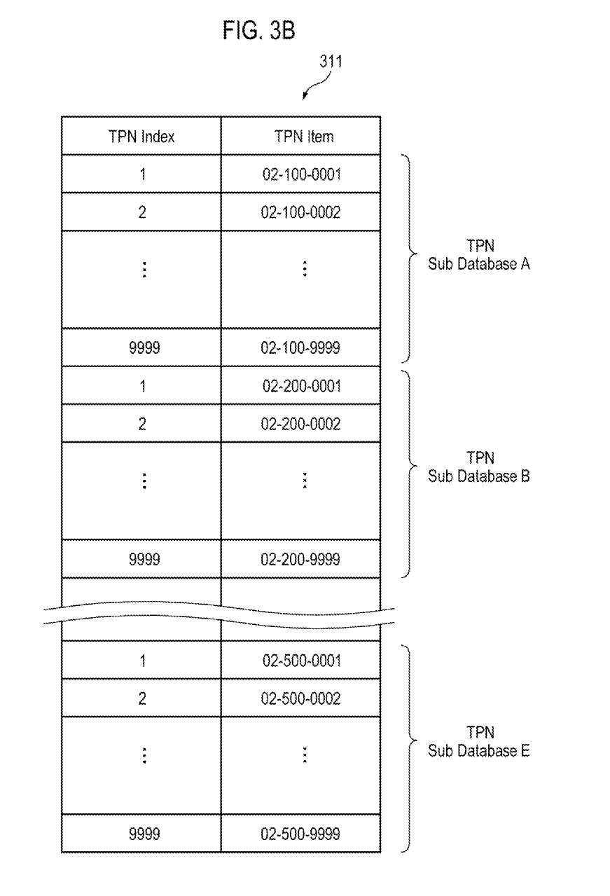

FIG. 4A illustrates a TPN generator displaying a TPN in accordance with one embodiment of the present disclosure. Referring to FIG. 4A, the TPN generator 130 may be implemented as an electronic device 400 including a button 410 and a screen 420 to display a TPN when the button 410 is pressed. The TPN generator 400 shown in FIG. 4A may come in various shapes and/or sizes in its implementation. For example, the TPN generator 400 may be of a portable size and shape that would make it convenient for a person to carry it around and use it to provide a TPN for his/her communication terminal whenever needed (e.g., when other person requests his/her phone number). In another example, the TPN generator 400 may be installed at and/or fixed to certain places, such that anyone nearby may obtain a TPN. In the above example, the TPN generator 400 may be installed inside a rental car, such that a person renting the car may obtain a TPN for the responsible auto mechanic, e.g., when the car breaks down, without the actual phone number of the auto mechanic being exposed to the person renting the car. Further, the TPN generator 400 may be installed at and/or near a communication terminal (e.g., the communication terminal 120 in FIG. 1) to provide a TPN whenever needed.

The TPN generator need not necessarily be a separate electronic device that is used exclusively for providing TPNs. In one embodiment, the TPN generator may be a multi-function electronic device (e.g., a mobile phone or a smart phone) that is installed with software to generate TPNs. In such an embodiment, the TPN serial number may be, e.g. an identification number associated with the mobile or smart phone, e.g. an international mobile station equipment identity (IMEI) or a WiFi media access control (MAC) address. FIG. 4B illustrates a TPN generator displaying a TPN in accordance with another embodiment of the present disclosure. Referring to FIG. 4B, the TPN generator 130 may be a mobile phone 450 that includes a plurality of input keys 460 and a screen 470 and is installed with software to display a TPN on the screen 470 when the input keys 460 are manipulated in a prescribed manner. In one embodiment, the TPN generator 450, being a mobile phone, may be configured to generate a TPN, which, if called, would connect to the mobile phone 450. In another embodiment, the TPN generator 450 may be configured to generate a TPN for another communication terminal (e.g., a TPN for a wired telephone at one's work place or home).

It should be further appreciated that the TPN generator in accordance with the present disclosure may include additional structural and/or functional units, store additional and/or different types of data, and perform operations other than those described in conjunction with FIGS. 2 to 4B.

FIG. 5 shows a detailed block diagram of an illustrative embodiment of the telephone switch shown in FIG. 1. Referring to FIG. 5, the telephone switch 151 may include, without limitation, a communication unit 510 and a control unit 520.

The communication unit 510 may be configured to assist in establishing communication between communication entities (e.g., the first and second communication terminals 110 and 120, the communication network 140, and the APN server 152 in FIG. 1). In one embodiment, the communication unit 510 may receive a communication request (e.g., a call request) directed to a TPN, from a communication terminal (e.g., the first communication terminal 110) via the communication network 140.

The control unit 520 is configured to manage the overall operation of the telephone switch 152. In one embodiment, the control unit 520 may be configured to, upon receiving a communication request via the communication unit 510, extract the TPN from the communication request, and send the extracted TPN to the APN server 152 via the communication unit 510. In one embodiment, the control unit 520 may be configured to either forward or suspend the communication request depending on whether the APN corresponding to the extracted TPN is received from the APN server 152 via the communication unit 520.

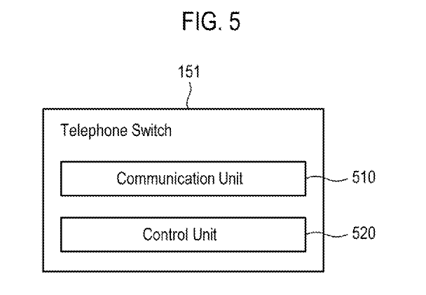

FIG. 6 shows a detailed block diagram of an illustrative embodiment of the actual telephone number (APN) server 152 shown in FIG. 1. Referring to FIG. 6, the APN server 152 may include, without limitation, a storage unit 610, a clock 620, and an APN processor 630.

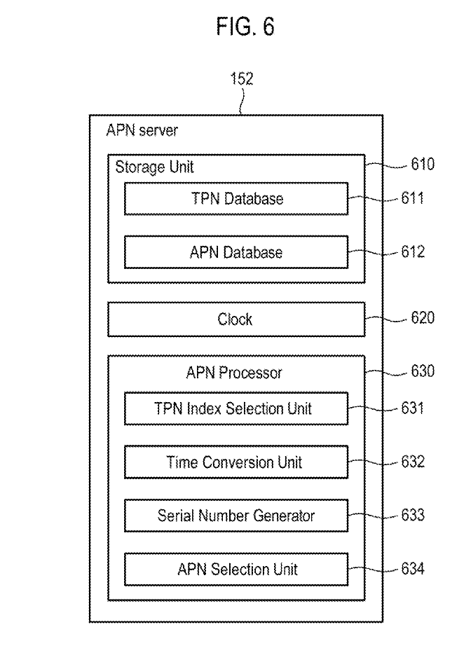

The storage unit 610 may be configured to store a TPN database 611 that stores a plurality of TPN items indexed with numbers ranging from 1 to the total number of TPN items. FIG. 7A illustrates a non-limiting example in which the TPN database 611 stores 9999 number of TPN items ranging from 02-100-0001 to 02-100-9999 respectively indexed with natural numbers from 1 to 9999. As can be understood from FIGS. 3A and 7A, which illustrate the same TPN database, the storage unit 610 may store the same TPN database as the one stored in the TPN generator 130). In one embodiment, the TPN items and their TPN indices stored in the TPN database 611 may be shared by a plurality of TPN generators subscribed to the backend service provider 150.

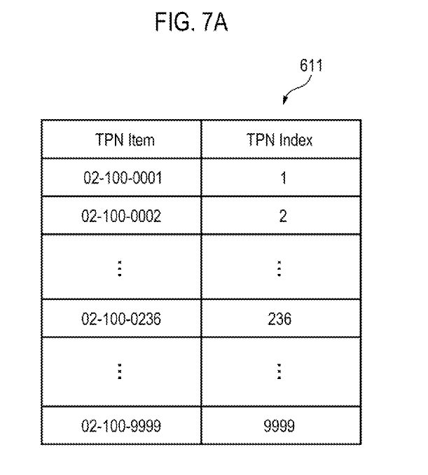

The storage unit 610 may further include an APN database 612 configured to store at least one APN item in association with the identification information of the TPN generators subscribed to the backend service provider 150 (e.g., the serial number of the TPN generator 130 in FIGS. 1 and 2). FIG. 8 illustrates a plurality of APN items stored in association with a plurality of serial numbers of TPN generators according to one embodiment of the present disclosure. The APN database 612 includes a plurality of APN items ranging from 02-900-9000 to 02-900-9999 and a plurality of serial numbers corresponding thereto (e.g., ABCD0001, ABCD0002, and ABCD9999). By way of a non-limiting example, each of the serial numbers may be the serial numbers of the TPN generators, including the TPN generator 130, subscribed to the backend service provider 150, and each of the APN items may the actual phone number of the communication terminals subscribed to the backend service provider 150.

Referring back to FIG. 6, in one embodiment, the clock 620 may be configured to provide the time of arrival of a TPN received by the APN server 152 (e.g., the time the APN server 152 received a TPN from the telephone switch 151). In one embodiment, the clock 620 may be configured to generate a number indicative of the time, date, and/or year of arrival. The structural configurations and functions of the clock 620 are similar to the clock 220 in FIG. 2, and for the sake of simplicity, the details on the clock 620 are not further explained.

The APN processor 630 may be configured to, upon receiving a TPN, select one of the APN items stored in the storage unit 610, based on the received TPN and the time of arrival of the TPN provided by the clock 620. In one embodiment, the APN processor 630 may include a TPN index selection unit 631 configured to retrieve from the TPN database 611 one of the TPN indices corresponding to the TPN item that matches the received TPN. In one example, the TPN index selection unit 631, upon receiving the TPN 02-100-0236, may select the TPN index 236, which is associated with the TPN item 02-100-0236 in the TPN database 611.

In one embodiment, the APN processor 630 may further include a time conversion unit 632 configured to convert the number indicative of the time, date, and/or year of arrival of the TPN provided by the clock 620 to a time period number. The structure and functions of the time conversion unit 632 are similar to the time conversion unit 231 in FIG. 2, and for the sake of simplicity, the details on the time conversion unit 632 are not further explained.

In one embodiment, the APN processor 630 may further include a serial number generator 633 configured to generate a serial number based on the TPN index selected by the TPN index selection unit 631 and the time period number provided by the time conversion unit 632. In one embodiment, the serial number generator 633 may be configured to perform a serial number generating algorithm, i.e., one or more operations that are inverse to those performed by the random number generating algorithm in the TPN generator 130. In one embodiment, serial numbers may be generated according to the following equation:

S=(R−random(t))mod(TPN_#) (Eq. 2)

where R denotes a TPN index, S denotes a serial number (may be smaller than TPN_#), random( ) denotes a random number generating function, t denotes a time period number, TPN_# denotes the total number of TPN items in a TPN database, and S is smaller than TPN_#. Any random number generating function (e.g., the linear congruential generating function) may be employed in generating the serial number. In cases where the serial number is comprised of alphanumeric characters, hexatridecimal numbers, instead of decimal numbers, may be used in the above equation.

In the above embodiment, owing to the inverse relationship in operation between the random number generating algorithm and the serial number generating algorithm, the serial number generator 633 may generate the same serial number as that of the TPN generator 130 as long as the TPN index selected by the TPN index selection unit 631 and the time period number provided by the time conversion unit 632 are respectively identical to those used by the TPN generator 130 in generating the received TPN. Thus, if the received TPN is mapped by the TPN index selection unit 631 to the same number as was generated by the random number generator 232 of the TPN generator 130, the serial number generator 633 can generate the same serial number as that of the corresponding TPN generator 130 under the condition that the TPN is received in the same time period in which the received TPN was generated by the TPN generator 130. For instance, if the received TPN 02-100-0236 was generated by the TPN generator 130 with the random number 236 and the time period number 3 corresponding to the time 18:01:00 UTC, Jan. 1, 1970 for a series of successive six-hour long time periods, assuming that the TPN index selection unit 631 selects the TPN index 236 from the TPN database 611, the serial number generator 633 may generate the same serial number as that of the TPN generator 130 as long as the TPN was received by the APN server 152 in the time period between 18:00:00 UTC, January 1, 1970 and 23:59:59 UTC, January 1, 1970 and the time period number 3 is provided by the time conversion unit 632.

The APN processor 630 may further include an APN selection unit 634 configured to select one of the APN items in the APN database 612 by identifying one of the serial numbers in the APN database 612 that matches the generated serial number. In one embodiment, the APN selection unit 634 may be configured to select an APN item in the APN database 612 that is mapped from the generated serial number. In one example, the APN selection unit 634, upon receiving the serial number ABCD0001 from the serial number generator 633, may select the APN item 010-111-1111, which is associated with the serial number ABCD0001 in the APN database 612 (see FIG. 8), as an APN corresponding to the received TPN.

While the clock 620 and the time conversion unit 632 in the above embodiment has been respectively described as providing a number indicative of the current time and converting the number indicative of the current time to time period number, it should be appreciated that the clock 620 and the time conversion unit 632 may operate in a different manner to generate time period number. In one embodiment, the clock 620 may be configured to provide a clock signal of a predetermined period. In this embodiment, the time conversion unit 632 may be configured to receive the clock signal from the clock 620 and generate a time period number based on the received clock signal. By way of a non-limiting example, the time conversion unit 632 may generate time period number, and regularly update the time period number at the passing of a predetermined period of time as determined from the received clock signal. In the above example, the time conversion unit 632 may continuously generate time period numbers indicative of the current time, date, and/or year (e.g., generate the time period number 070113 indicative of Jul. 1, 2013, and then, generate on the next day the time period number 070213 indicative of Jul. 2, 2013).

Further, it should be appreciated that an APN server in accordance with the present disclosure may include structural and/or functional units, store data, and perform operations other than those described in conjunction with FIGS. 6, 7A, and 8. In one embodiment, the time conversion unit 632 of the APN server 152 may be configured to support a plurality of sets of predetermined time periods by converting the numbers provided by the clock 620 to the numbers corresponding to one of the plurality of sets of predetermined time periods (e.g., a first set of successive one-hour long time periods, a second set of successive six-hour long time periods, etc.).

In the above embodiment, the storage unit 610 may store a plurality of TPN sub-databases respectively associated with the plurality of different sets of predetermined time periods. FIG. 7B illustrates a non-limiting example in which the TPN database 611 includes five TPN sub-databases (i.e., TPN sub-databases A to E), and each of the TPN sub-databases stores 9999 TPN items for different sets of predetermined time periods of different durations. For example, the TPN sub-database A may provide TPN items for the first set of successive one-hour long time periods, and the TPN sub-database B may provide TPN items for the first set of successive six-hour long time periods. By way of a non-limiting example, each of the plurality of TPN databases may store a range of TPN items that do not overlap with the TPN items stored in other TPN databases. For instance, as shown in FIG. 7B, the TPN sub-database A associated with the first set of successive one-hour long time periods may store TPN items ranging from 02-100-1001 to 02-100-9999, whereas the TPN sub-database B associated with the second set of successive six-hour long time periods may store TPN items ranging from 02-200-1001 to 02-200-9999. In this embodiment, the TPN index selection unit 631 may be configured to select one of the TPN items as a TPN from the entire TPN sub-database. Due to the non-overlap of TPN items between the TPN sub-databases, the received TPN uniquely determines which sub-database was used for the TPN generation.

Further, in one embodiment, the TPN database 611, the APN database 612, and/or the serial number generating algorithm used in the serial number generator 633 may be updated, for example, by an operator of the APN server 152. For example, the TPN database 611, the APN database 612, and/or the serial number generating algorithm may be updated on regular intervals (e.g., one day, ten days, or one month).

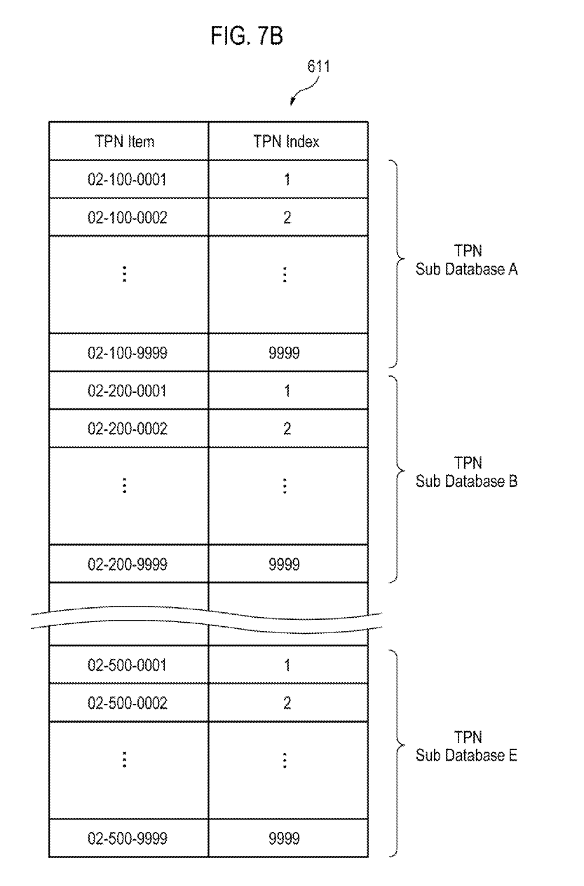

FIG. 9 is a flowchart of a method, e.g. performed by a TPN generator, such as the TPN generator 130, for generating and displaying a TPN according to one embodiment of the present disclosure. Referring to FIG. 9, in block 910, e.g. performed by the time conversion unit 231 of the TPN generator 130, a number indicative of the current time provided by the clock 220 is converted into a time period number. In block 920, e.g. performed by the random number generator 232 of the TPN generator 130, a random number is generated based on the serial number of the TPN generator 130 stored in the storage unit 210 and the time period number is provided by the time conversion unit 231. In block 930, e.g. performed by the TPN selection unit 233 of the TPN generator 130, one of the TPN items that matches the generated random number is retrieved from the TPN database 211. In one embodiment, in block 940, e.g., performed by the output unit 240, the TPN item is output as a TPN to at least one of a display device, a speaker, or a tactile device, for example, installed in the TPN generator 130.

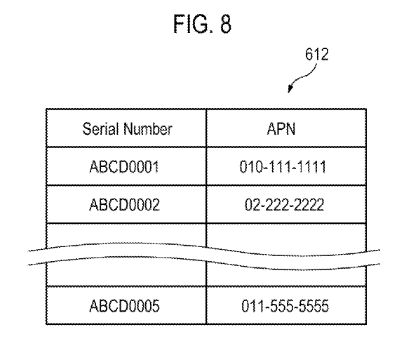

FIG. 10 is a flowchart of a method, performed by a telephone switch, e.g. the telephone switch 151, for forwarding a communication request to the destination communication terminal according to one embodiment of the present disclosure. Referring to FIG. 10, in block 1010, e.g. performed by the communication unit 510 of the telephone switch 151, a communication request directed to a TPN is received from the first communication terminal 110 via the communication network 140. In block 1020, e.g. performed by the control unit 520 of the telephone switch 151, the TPN is extracted from the communication request, and in block 1030, the extracted TPN is provided to the APN server 152. Thereafter in block 1040, e.g. performed by the control unit 520, if an APN corresponding to the extracted TPN is received from the APN server 152, the process moves to block 1050 in which appropriate switching/relaying operations are performed to have the communication request relayed and/or forwarded toward the second communication terminal 120 having the APN as its actual phone number, to thereby enable a call establishment between the first and second communication terminals 110 and 120. On the other hand, if an APN is not received, the process moves to block 1060, e.g. performed by the control unit 520, in which the communication request is suspended.

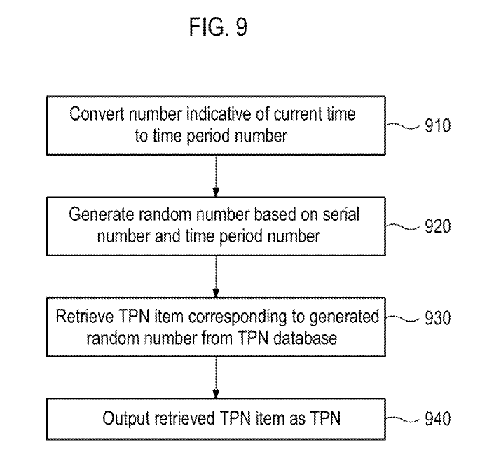

FIG. 11 is a flowchart of a method, e.g. performed by the APN server 152, for providing an APN of a destination communication terminal according to one embodiment of the present disclosure. Referring to FIG. 11, in block 1110, e.g. performed by the APN processor 630 of the APN server 152, a TPN is received from the telephone switch 151. In block 1120, e.g. performed by the TPN index selection unit 631 of the APN processor 630, one of the TPN indices that matches the received TPN is retrieved from the TPN database 611. In block 1120, e.g. performed by the time conversion unit 632 of the APN server 152, a number indicative of the time of arrival of the received TPN provided by the clock 620 is converted into a time period number. In block 1140, e.g. performed by the serial number generator 633 of the APN processor 630, a serial number is generated based on the TPN index retrieved by the TPN index selection unit 631 and the time period number provided by the time conversion unit 632. In block 1150, e.g. performed by the APN selection unit 634 of the APN processor 630, an APN item that matches the generated serial number is retrieved from the APN database 612.

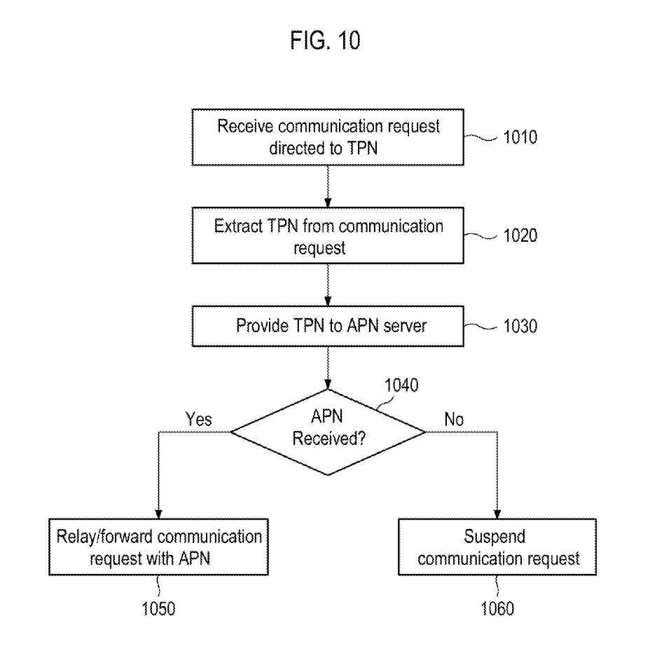

The system, the devices, and the methods described hitherto may be employed to provide temporary contact information (TCI) other than phone numbers. In one embodiment, the TCI may include at least one of: a temporary telephone number, a temporary email address, a temporary IP address, and a temporary uniform resource identifier (URI). FIG. 12 illustrates a TCI generator displaying a temporary email address in accordance with one embodiment of the present disclosure. Referring to FIG. 12, the TCI generator 1200 may be an electronic device including a button 1210 and a screen 1220 to display a temporary email address when the button 1210 is pressed.

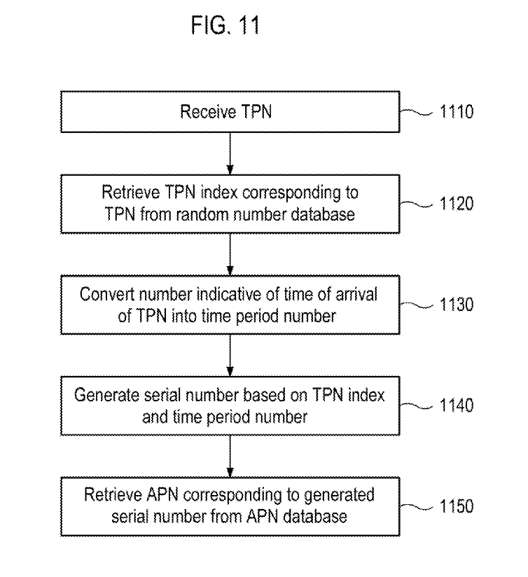

FIG. 13 illustrates a schematic diagram of a TCI communication system according to an embodiment of the present disclosure. The TCI communication system 1300 may include: a TCI generator 1310, data terminals 1320 and 1330, a web service provider 1340, a communication network 1350, and a backend service provider 1360.

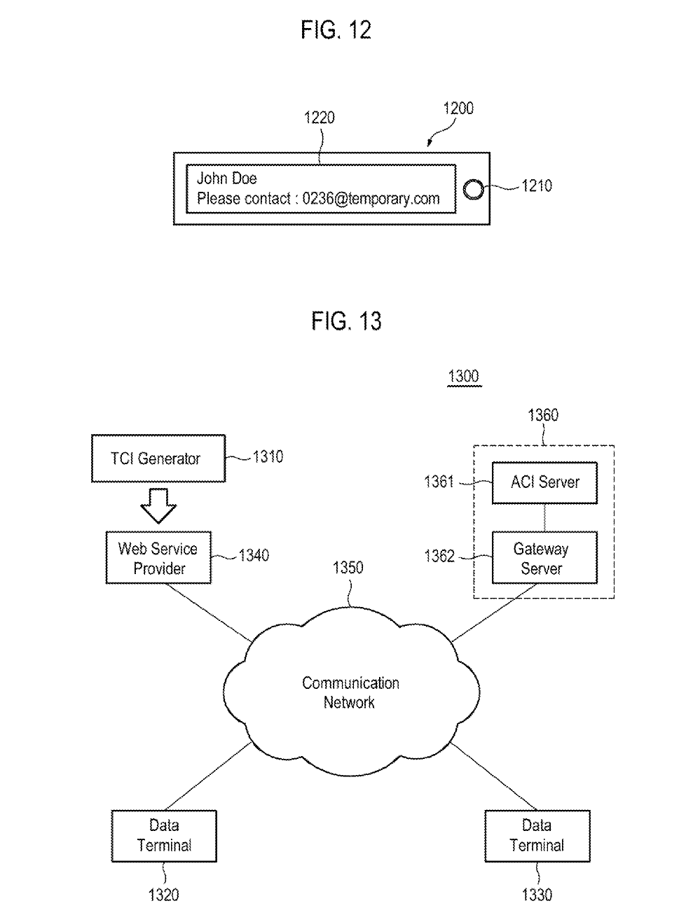

The TCI generator 1310 may be configured to generate and output a TCI (e.g., a temporary email address) for particular actual contact information (ACI) (e.g., an actual email address). For instance, the TCI generator 1310 may generate a temporary email address ending with a particular domain name (e.g., “@temporary.com”) for an actual email address ending with an actual domain name (e.g., “@actual.com”). The TCI generator 1310 may generate the temporary email in the same manner as those described with respect to the TPN generator 130 described with respect to FIGS. 1 to 11, except for TPNs being replaced with temporary email addresses. FIG. 14 shows a plurality of TCI items (i.e., temporary email addresses) stored in a TCI database 1411 in association with a plurality of TCI indices according to one embodiment of the present disclosure.

The data terminals 1320 and 1330 may be configured communicate with the web service provider 1340, the backend service provider 1360, and optionally, other entities (not shown) via the communication network, 1350. In one embodiment, the data terminals 1320 and 1330 may be configured to transmit and receive data (e.g., an e-mail) to the backend service provider 1360. For instance, the data terminal 1320 may transmit an e-mail directed to an email address ending with “@temporary.com” provided by the TCI generator 1310.

The web service provider 1340 may be configured to provide any type of web services known in the art (e.g., a web-based email service). For example, the web service provider 1340 may provide a plurality of email addresses with a particular domain name (e.g., email addresses ending with “@actual.com”). The technical details relating to such web service providers are well known in the art and will not be described herein in detail.

The communication network 1350 may be comprised of one or more networks, such as the Internet. The communication network 1350 may act as a medium for relaying and routing data (e.g., an e-mail) between entities connected thereto (e.g., the data terminals 1320 and 1330, the web service provider 1340, and the backend service provider 1360).

In one embodiment, the backend service provider 1360 may include a gateway server 1361 and an ACI server 1362. The gateway server 1361 may be assigned with the domain name “temporary.com” and the corresponding IP address, such that all e-mails directed to email addresses ending with “@temporary.com” are relayed to the gateway server 1361 of the backend service provider 1360 via the communication network 1350.

In one embodiment, the gateway server 1361 may be configured to, upon receiving an email directed to a temporary email address ending with “@temporary.com,” extract the temporary email address from the email and send the extracted temporary email address to the ACI server 1362. Further, the gateway server 1361 may be configured to, upon receiving an actual email address of the extracted temporary email address (e.g., an actual email address ending with “@actual.com”), forward/relay the received email to the web service provider 1340, such that the recipient of the email may log onto the email service of the web service provider 1340 to access the received email.

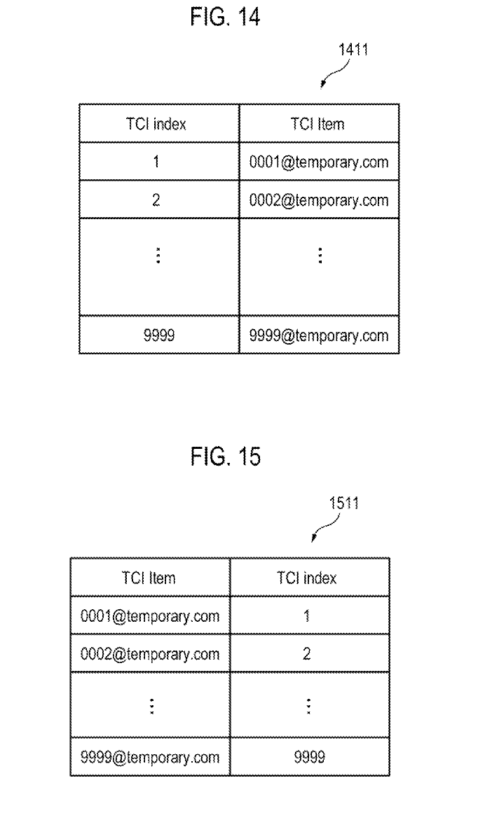

In one embodiment, the ACI server 1362 may be configured to, upon receiving a temporary email address, obtain and send an actual email address corresponding to the received temporary email address to the gateway server 1361. The ACI server 1362 may obtain the actual email address in the same manner as described with respect to the APN server 152 in conjunction with FIGS. 1 to 11, except for TPNs and APNs being replaced with temporary email addresses and actual email addresses. FIG. 15 shows a plurality of TCI indices stored in a TCI database 1511 in association with a plurality of

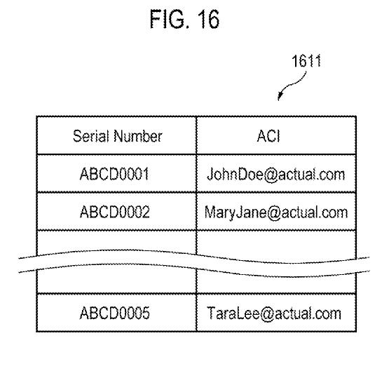

TCI items according to one embodiment of the present disclosure. FIG. 16 illustrates a plurality of ACI items stored in an ACI database 1611 in association with a plurality of TCI serial numbers of TCI generators according to another embodiment of the present disclosure.

Portions of the disclosed subject matter and corresponding detailed description are presented in terms of software, algorithms, or symbolic representations of operations on data bits within a computer memory. An algorithm, as the term is used herein, and as it is used generally, refers to one or more operations or steps leading to a desired result. The operations or steps may be those that require physical manipulations of physical quantities or properties. Typically, such quantities or properties take the form of optical, electrical, or magnetic signals capable of being stored, transferred, combined, compared, or otherwise manipulated. For convenience, such signals are referred to herein as bits, data, values, elements, symbols, characters, terms, numbers, streams, or the like.

It should be borne in mind, however, that all of these and similar terms are to be associated with the appropriate physical quantities and properties and are merely convenient labels applied to such quantities and properties. Unless specifically stated otherwise, or as is apparent from the description, terms such as “processing,” “computing,” “calculating,” “determining,” “displaying,” “receiving,” “demodulating,” “generating,” “demapping,” “combining,” “decorrelating,” “applying,” “maximizing,” “minimizing,” “aligning,” “multiplying,” “filtering,” or the like, may refer to the action and processes of a computer system, or similar electronic computing device, that manipulates and transforms data represented as physical, electronic quantities within the computer system's registers and memories into other data similarly represented as physical quantities within the computer system memories, registers, or other such information, storage, transmission, or display devices.

It should also be appreciated that the software implemented aspects of the disclosed subject matter are typically stored on some form of program storage medium or implemented over some type of transmission medium. The program storage medium may be any suitable media capable of storing data or signals such as a hard drive, tape, CD-ROM, DVD, blu-ray, RAM, ROM, flash memory, solid state drive, etc. Similarly, the transmission medium may be twisted wire pairs, coaxial cable, optical fiber, or some other suitable transmission medium known to the art. The disclosed subject matter is not limited by these aspects of any given implementation.

While embodiments of present disclosure may be susceptible to various modifications and alternative forms, specific embodiments have been shown by way of example in the drawings and have been described in detail herein. However, it should be understood that the embodiments of present disclosure are not intended to be limited to the particular forms disclosed. Rather, the embodiments are intended to cover all modifications, equivalents, and alternatives falling within the spirit and scope of the present disclosure as defined by the following appended claims.

1. A device, comprising:
identification information;
a storage unit configured to store the identification information and a plurality of temporary contact data items;
a processor configured to select one of the temporary contact data items based on the identification information and a first time index; and
an output unit configured to output the selected temporary contact data item.

2. The device of claim 1, wherein the temporary contact data items stored in the storage unit comprise data items generated from the identification information and second time indices.

3. The device of claim 2, wherein the processor is further configured to select the data items generated from the identification information and one of the second time indices identical to the first time index.

4. The device of claim 2, wherein the first time index and the second time indices respectively include a first time period number and second time period numbers, the second time period numbers being indicative of a series of predetermined time periods, respectively, and the first time period number being indicative of one of the series of predetermined time periods.

5. The device of claim 4, further comprising a clock, and wherein the first time period number is related to a current time of the clock.

6. The device of claim 1, wherein the processor comprises a random number generator configured to generate a random number based on the identification information and the first time index.

7. The device of claim 6, wherein the processor further comprises a temporary contact information selection unit configured to select one of the temporary contact data items based on the random number.

8. The device of claim 1, wherein the device comprises a clock, and the processor comprises a time conversion unit configured to determine the first time index based on a current time of the clock.

9. The device of claim 1, wherein the selected temporary contact data item comprises at least one of: a temporary telephone number, a temporary email address, a temporary IP address, and a temporary uniform resource identifier (URI).

10. A method, comprising:
retrieving identification information from a storage unit, the storage unit storing a plurality of temporary contact data items;
selecting one of the temporary contact data items based on the retrieved identification information and a first time index; and
outputting the selected temporary contact data item as the temporary contact information.

11. The method of claim 10, wherein the temporary contact data items stored in the storage unit comprise data items generated from the identification information and second time indices.

12. The method of claim 11, wherein selecting comprises selecting the data items generated from the identification information and one of the second time indices identical to the first time index.

13. The method of claim 10, wherein selecting comprises:
generating a random number based on the identification information and the first time index; and
selecting one of the temporary contact data items based on the random number.

14. The method of claim 10, wherein the temporary contact information comprises at least one of: a temporary telephone number, a temporary email address, a temporary IP address, and a temporary uniform resource identifier (URI).

15. A device, comprising:
a storage unit configured to store a plurality of actual contact data items of a plurality of respective communication devices in association with identification information of temporary contact information generating devices; and
a processor configured to:
receive temporary contact information,
generate identification information based on the temporary contact information and a first time index for the temporary contact information, the identification information identifying a particular one of the temporary contact information generating devices, and
retrieve one of the actual contact data items associated with the identification information from the storage unit.

16. The device of claim 15, wherein the processor comprises a time conversion unit configured to generate the first time index based on a time of receiving the temporary contact information.

17. The device of claim 15, wherein the storage unit is configured to further store a plurality of temporary contact information indices, and the processor comprises a temporary contact information index selection unit configured to retrieve one of the plurality of temporary contact information indices associated with the temporary contact information from the storage unit.

18. The device of claim 17, wherein the processor comprises an identification information generator configured to generate the identification information based on the retrieved one of the temporary contact information indices and the first time index.

19. The device of claim 15, wherein the retrieved temporary contact information comprises at least one of: a temporary telephone number, a temporary email address, a temporary IP address, and a temporary uniform resource identifier (URI).

20. A method, comprising:
receiving temporary contact information;
generating identification information based on the temporary contact information and a first time index for the temporary contact information, the identification information identifying a temporary contact information generating device; and
retrieving, from a storage unit storing a plurality of actual contact data items of a plurality of respective communication devices, one of the actual contact data items associated with the identification information.

21. The method of claim 20, further comprising generating the first time index based on a time of receiving the temporary contact information.

22. The method of claim 20, wherein generating comprises:
retrieving, from the storage unit further storing a plurality of temporary contact information indices, one of the plurality of temporary contact information indices associated with the temporary contact information; and
generating the identification information based on the retrieved one of the temporary contact information indices and the first time index.

23. The method of claim 20, wherein the retrieved one of the plurality of the temporary contact information comprises at least one of: a temporary telephone number, a temporary email address, a temporary IP address, and a temporary uniform resource identifier (URI).

24. The method of claim 20, wherein said one of the actual contact data items corresponds to actual contact information of one of the communication devices.
